(19) United States
(12) Patent Application Publication
(10) Pub. No.: US 2007/0137094 A1
(43) Pub. Date: Jun. 21, 2007

(54) Fishing lure including looped fiber-based materials

(76) Inventor: Michael Patrick, Masonville, NY (US)

Correspondence Address: MARJAMA & BILINSKI LLP, 250 SOUTH CLINTON STREET, SUITE 300, SYRACUSE, NY, 13202, US

(21) Appl. No.: 11/305,622

(22) Filed: Dec. 16, 2005

(51) Int. Cl. A01K 85/00; A01K 85/08

(52) U.S. Cl. 43/42.25; 43/42.26

(57) ABSTRACT

Fishing lures are provided that include a shank and a plurality of closed or substantially closed loops of fiber-based material that are attached to and extend from the shank, and, if desired, to and from other portions of the lure and/or to and from one or more lure attachments, so as to enable the teeth of a fish to become and remain entangled within the fiber loops whether or not the lure includes a hook.

### FIELD OF THE INVENTION

This invention relates in general to fishing lures and, more particularly, to fishing lures including a plurality of closed or substantially closed loops made of fiber-based material, wherein such lures may be used either alone or in combination with one or more hooks.

### BACKGROUND OF THE INVENTION

Fishing lures have many different designs and are made from a variety of materials; however, what the majority of currently manufactured lures have in common is their incorporation of one or more barbed hooks. Whereas the purpose of the lure is to entice fish, the hook is utilized to actually ensnare (i.e., catch) the fish, which occurs when the hook is taken into the mouth of the fish and either swallowed or embedded in its jaw or mouth, or which occurs when the hook is set into the mouth of the fish by either the striking of the lure or by a quick tug or jerk on the fishing line.

Although use of a hook is beneficial in that once a fish is hooked it is difficult for the fish to free itself, that fact actually can be a drawback in some instances. For example, many sport fishermen prefer to release a caught fish back to the wild when it is smaller than a set size, or in order to conserve the fish population at a specific location. However, if a hook becomes lodged in the mouth, jaw or internal organs of a fish, then the fish may not survive after the hook is removed due to the damage caused by the hook itself and/or auxiliary damage resulting from a struggle as the fish was being caught.

Moreover, it requires deftness on the part of a fisherman to quickly recognize the first strike of a fish on a lure, react to the strike, and set the hook in a manner to successfully catch the fish. Indeed, not infrequently, a fish may strike and release or spit out the lure before even a skilled fisherman has time to set the hook. This is especially the case where the lure is man-made and thus does not simulate the texture of the actual prey of the fish, since that will reduce the time it takes for the fish to deduce that the lure is artificial.

Perhaps in recognition of these drawbacks and disadvantages, those in the art have attempted to minimize or obviate the problems associated with utilizing a hooked lure. For example, U.S. Pat. No. 4,158,927 to Capra et al. (the entirety of which is incorporated by reference herein) discloses the use of curled strands of material either alone or in combination with barbed hooks, with the idea being that the teeth of a fish will bite down upon the curled material and in turn, the fish will be inhibited from freeing itself while the fisherman accurately sets the hook. However, this attempted solution has proven ineffective in practice, since the curled strands become straightened and slide through the fish's teeth once an ensnared fish begins to tug upon the strands, thus not reliably allowing a fisherman enough time to set the hook. Moreover, the curled strands of material are typically bound to a fabric or rubberized backing, which limits how the strands may be used as well as their accessibility to a fish.

Another attempt to solve the known drawbacks associated with hooked lures is through use of lures that do without a hook. For example, U.S. Pat. No. 3,757,452 to Parker discloses a tassle-like arrangement of a bundle of elongate fibers. The fibers are intended to catch certain fish by contacting and adhering to their body, e.g., the rough scaly surface on their bill. This attempted solution is replete with disadvantages, most notably the fact that only a very small subset of the overall fish population (e.g., billfish, marlin) has the required scaly bill to enable adherence of the fibers.

Thus, there remains a need for a fishing lure with an appearance that entices a fish to latch onto the lure with its teeth and that keeps the teeth of the fish ensnared long enough for fishermen of varying skill to set a hook in place, and that provides an option of catching a fish without utilizing a hook such that a caught fish can be returned to the water substantially unharmed.

### SUMMARY OF THE INVENTION

These and other needs are met by the present invention, which provides various designs for fishing lures that incorporate a plurality of closed or substantially closed loops of fiber-based material, wherein fish are caught by virtue of their teeth becoming and remaining entangled within the fiber loops.

The fiber-based loops can be shaped to simulate or to enhance the appearance of all or part of a fishing lure in order to further increase the likelihood that the lure can successfully attract and catch fish. Additional materials and/or equipment can be added to enhance the attractiveness of the lures to a fish, e.g., by increasing the color, shininess and/or reflectivity of the lure.

Moreover, the fiber-based loops can be utilized with-lures that do not incorporate a hook, thus better enabling one to catch fish that can be subsequently returned to water substantially unharmed. If preferred, however, the fiber-based loops can be utilized with a hooked lure or can be incorporated onto a hook (e.g., as a skirt), which then can be added to a lure.

The fiber-based loops can be attached to a shank and/or other portions (e.g., a hook or other attachment) of a lure by various techniques (e.g., tying and/or sewing), wherein certain aspects (e.g., length, amount, size) of the fiber-based loops can be varied depending on factors such as the type of fish sought to be caught and/or the design of the lure. The fiber-based material from which the loops are made can vary, but generally has characteristics that provide the loops—and thus the lure—with durability and floatation.

### BRIEF DESCRIPTION OF THE DRAWINGS

For a further understanding of these and other objects of the invention, reference will be made to the following detailed description of the invention which is to be read in connection with the accompanying drawing, where:

FIG. 1 is a side view of a shank of a fishing lure in accordance with an exemplary embodiment of the present invention;

FIG. 2 is a side view of the fishing lure of FIG. 1;

FIG. 3 is an enlarged view of the encircled region of FIG. 1 depicting the looped arrangement of the fiber-based materials;

FIG. 4 is a side view of an exemplary embodiment of the present invention in which a skirt of fiber-based materials are attached to a spoon lure;

FIG. 5 is a side view of a hooked shank with a matrix of fiber-based material attached thereto;

FIG. 6 is a side view of the hooked shank of FIG. 5 having been attached to a worm-type fishing-lure; and

FIG. 7 is a side view of a crankbait-type lure with a plurality of fibers attached to a plurality of trebel hooks attached thereto.

### DETAILED DESCRIPTION

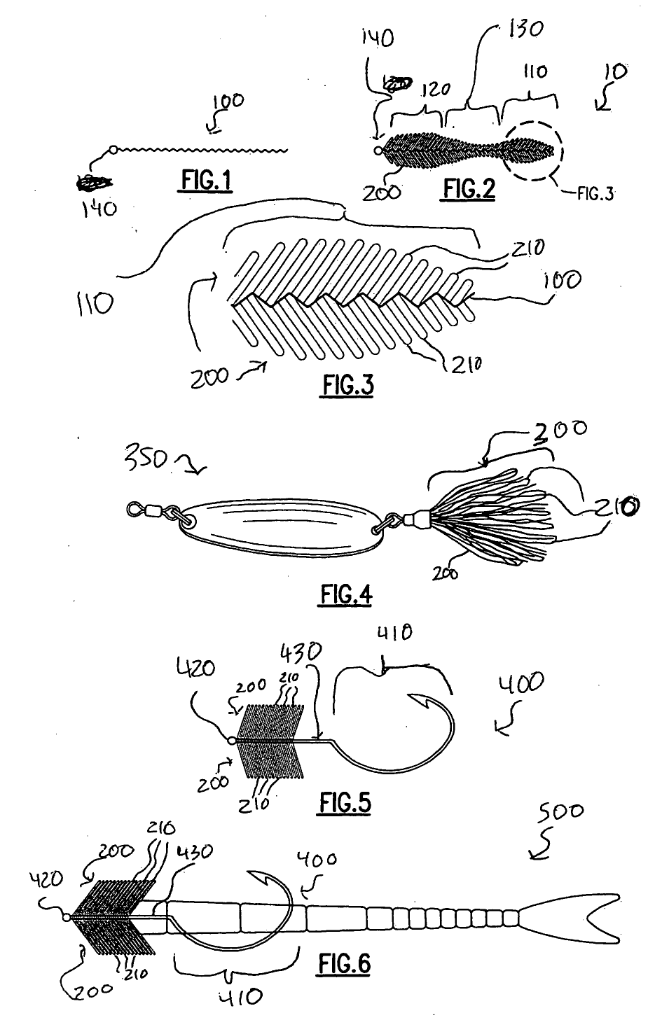

Referring initially to FIGS. 1 and 2, a plug type fishing lure 10 is shown that includes a shank 100 with a matrix of fiber-based material 200 attached or bundled thereto. The term “shank,” as recited herein, refers to the main body of a lure or the main body of a lure attachment (e.g., a hook). As is best illustrated in FIG. 2, the shank 100 has a tail portion 110, an eye portion 120 and a shank body 130 therebetween. The eye portion 120 of the shank 100 culminates in an opening (e.g., an eye) 140, at which a fishing line (not shown) or other suitable fishing equipment can be attached.

In an exemplary embodiment of the present invention, and as depicted in FIGS. 1 and 2, the shank 100 is substantially straight/linear and is made of a thin, durable material, e.g., a segment of wire cord. However, it should be noted that shape characteristics of the shank 100 depicted in FIGS. 1 and 2 can be varied in accordance with the present invention for various reasons including, but not limited to the type of fish sought to be caught using the lure 10, and whether or not the shank has a hook attached thereto. For example, the length of the shank 100 can be increased or decreased and/or portions of the shank can be bent or curved in order to better replicate the length and/or the shape of the actual prey meant to be stimulated by or attracted to the lure.

As shown in FIG. 2, and as is currently preferred in accordance with the present invention, fiber-based material 200 is attached to substantially the entire shank 100 in order to maximize the likelihood that the teeth of a fish will become entangled within the fibers. The fiber-based material 200 should be attached to the shank 100 in a manner that ensures secure and reliable attachment, wherein suitable attachment techniques include, but are not limited to, tying and/or sewing and other like processes.

As is also currently preferred, the fiber-based material 200 is attached to the shank 100 so as to have a particular shape depending on its attachment location on the shank. For example, and as shown in FIG. 2, the fiber-based material 200 attached at the tail portion 110 of the shank 100 generally has a wider profile than the fiber-based material that is attached at the shank body 130, and the fiber-based material attached at the eye portion 120 generally has a wider profile than the fiber-based material that is attached at the tail portion.

This varied profile can be accomplished, e.g., by attaching comparatively longer fiber-based materials 200 at the tail portion 110 and comparatively even longer fiber-based materials at the eye portion 120, and/or by attaching comparatively more fiber-based materials at the tail portion and comparatively even more fiber-based materials at the eye portion. Such an attachment arrangement is advantageous in that it simulates the appearance of the actual prey meant to be attracted to or stimulated by the lure 10 while providing an increased likelihood that the teeth of a fish will become ensnared in some portion of the fiber-based materials 200 than if the amount and/or length of the fibers was uniform throughout the entirety of the shank 100.

FIG. 3 depicts a portion of the fiber-based material 200 attached to the shank 100 of lure 10. As shown in FIG. 3, at least some of the fiber-based material 200 is attached to the shank 100 to form a matrix of closed or substantially closed loops 210. By virtue of being closed or substantially closed, these loops 210 of fiber-based material 200 not only can ensnare the teeth of a fish but also can maintain the teeth within the matrix of fiber loops even if the fish tries to forcibly withdraw its teeth, e.g., by tugging on the loops or by swimming in various directions. The number of loops 210 of fiber-based material 200 can vary depending on several factors, including but not limited to, the type of fish sought to be caught, and whether or not the shank has a hook attached thereto. However, it is currently preferred for there to be a plurality of loops 210 of fiber-based material attached to the shank 100, e.g., at least 25 loops, wherein hundreds of loops also can be used.

According to a currently preferred embodiment of the present invention, the fiber-based material 200 used to form the plurality of loops 210 is stronger than steel (e.g., to provide durability and to ensure that the teeth of a fish cannot rip or chew through the fiber loops), has low moisture absorption (e.g., to provide longevity), is light-weight (e.g., to float), and/or has a fine or ultra-fine denier (e.g., to enable formation of a highly entangling web of fibers). Suitable fiber-based material 200 include, but are not limited to, polyethylene fiber materials such as Dyneema® fiber (which is commercially available from DSM Dyneema of Greenville, N.C. USA) and Spectra® fiber (which is commercially available from Honeywell International, Inc. of Colonial Heights, Va. USA).

The lure 10 of FIG. 2 can be utilized in connection with a fishing line or other fishing equipment (not shown) in order to catch fish without a hook, since the teeth of the fish can become, and will remain, ensnared within the loops 210 of fiber-based material 200. However, one or more additional pieces of material can be attached to the shank 100 in order to provide added enticement for the fish to become attracted to the lure 10. For example, one or more strands of colored, shiny and/or reflective material can be attached to the shank 100 so as to be blended within the matrix of loops 210 of fiber-based material 200, wherein the color, shininess and reflectivity of such strands of material will better enable the lure 10 to simulate the appearance and/or the behavior of a baitfish or minnow, which are the prey of many different types of fish that are sought to be caught by fishermen.

Alternatively, yet still in accordance with the present invention, a shank 100 with attached loops 210 of fiber-based material 200 can be arranged to form a skirt 300, which, in turn, can be attached to the tail end of a lure, e.g., a shiny and/or reflective spoon, blade, or, as shown in FIG. 4, a spoon lure 350. In accordance with such an embodiment of the present invention, a matrix of heavier, thicker fiber-based material can be placed beneath the loops 210 of fiber-based material 200 in order to help the loops of fiber-based material maintain their shape/profile.

Although not shown, fiber-based material 200 of the present invention also can be attached to a jig-type lure, (e.g., a jig-type lure with a split tail), wherein loops 210 of the fiber-based material can be attached to the sides and/or the tail of the jig. Moreover, fiber-based material 200 can be attached as loops 210 to other fishing-related lures and equipment, such as flies (e.g., wet flies, dry flies), streamers, poppers, eggs and eggsacks.

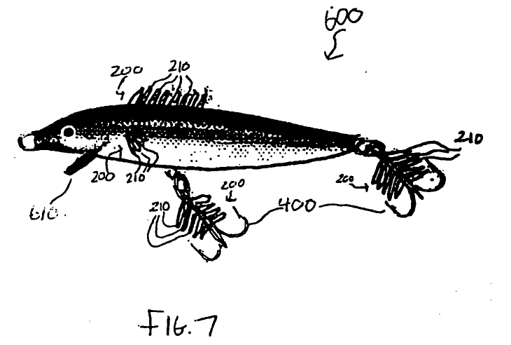

A lure 10 of the present invention also can incorporate a hook, if desired. For example, and as depicted in FIG. 5, a hooked lure 400 is shown having a hook end 410, an opening 420 (e.g., an eye) and a substantially straight/linear shank 430 therebetween. A plurality of loops 210 of fiber-based material 200 are attached (e.g., by sewing and/or tying) to the shank 430. The hooked lure 400 with attached loops 210 of fiber-based material 200 can be utilized as a lure or attached to one or more other lures, e.g., a worm lure 500 as shown in FIG. 6.

In an alternate embodiment of FIG. 5, loops 210 of fiber-based material 200 can be attached to the hooked end 410 of the hooked lure 400 (or another lure with a hook attached thereto) so as to partially or entirely visually obstruct or obscure the hooked end, which could otherwise serve as a visual deterrent to fish becoming attracted to the lure. Such attachment can be in addition to or in lieu of attaching fibers to the shank 430 of the hooked lure 400.

The hooked lure 400 also can be incorporated into a larger lure, as shown, for example, in FIGS. 6 and 7. In FIG. 6, the shank 430 of a hook 400 has fiber-based material 200 attached as loops 210 and is connected to a worm-shaped lure 500 as shown in FIG. 6. Although not shown, the hook 400 can be in the form of a trebel hook, as can the hook depicted in FIG. 5.

Similarly, one or more hooks 400 can be attached to a crankbait-type lure 600, as shown in FIG. 7, which is a fish-shaped type of lure that is usually made of wood or plastic and that has a bill 610 so as to enable the lure to better maneuver through water. Fiber-based material 200 is attached as loops 210 to one or more areas of the crankbait lure 600, e.g., to simulate the appearance of fins such as a dorsal fin. The one or more hooks 400 of the crankbait lure 600 also generally have fiber-based material 200 attached thereto as loops 210, again so as partially or entirely visually obstruct or obscure the hooked end, which could otherwise serve as a visual deterrent to fish becoming attracted to the lure.

The hooks 400 shown in FIG. 7 crankbait lure 600 are trebel hooks, but that design is not a requirement of the present invention—to wit, the hooks can be non-trebel hooks, such as those shown in FIGS. 5 and 6. Generally, in the FIG. 7 crankbait lure 600 embodiment the hooks 400 are attached at locations chosen to increase the likelihood of a fish being able to latch onto the hooks, yet also so as to minimally, if at all, visually obscure the enticing appearance of the lure. Such attachment locations can include, but are not limited to, at the tail and/or on the underside of the lure 600.

Although the present invention has been described herein with reference to details of currently-preferred embodiments, it is not intended that such details be regarded as limiting the scope of the invention, except as and to the extent that they are included in the following claims—that is, the foregoing description of the present invention is merely illustrative, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

We claim:

1. A fishing lure for capturing fish having teeth, the fishing lure comprising:
a shank; and
a plurality of substantially closed loops of fiber-based material attached to and extending from at least a portion of the shank.

2. The fishing lure of claim 1, wherein the substantially closed loops of fiber-based material are attached along substantially the entire shank.

3. The fishing lure of claim 1, wherein at least one of the amount, the length and the size of the substantially closed loops of fiber-based material is varied along the shank.

4. The fishing lure of claim 1, wherein the shank includes an opening at one end for attachment of additional fishing equipment.

5. The fishing lure of claim 1, wherein the substantially closed loops of fiber-based material are attached to the shank by a technique selected from the group consisting of tying, sewing, and a combination of tying and sewing.

6. The fishing lure of claim 1, further comprising at least one hook.

7. The fishing lure of claim 6, wherein at least some of the substantially closed loops of fiber-based material are attached to the shank so as to at least partially visually obscure the hook.

8. The fishing lure of claim 6, wherein the at least one hook has a trebel hooked end.

9. The fishing lure of claim 1, wherein the substantially closed loops of fiber-based material are attached to a tail end of the shank to form a skirt.

10. The fishing lure of claim 1, wherein at least one strand of additional material is attached to the shank to provide the lure with increased attractiveness to prey.

11. The fishing lure of claim 10, wherein the increased attractiveness is due to at least one characteristic selected from the group consisting of color, reflectivity and shininess.

12. The fishing lure of claim 1, wherein at least some of the substantially closed loops of fiber-based material are attached to the shank so as to simulate the appearance of prey.

13. The fishing lure of claim 12, wherein the at least some of the substantially closed loops of fiber-based material are attached to the shank so as to simulate the appearance of fins of prey.

14. The fishing lure of claim 1, wherein the fiber-based material is a polyethylene material.

15. A fishing lure for capturing fish having teeth, the fishing lure comprising:
a shank;
at least one hook; and
a plurality of substantially closed loops of fiber-based material attached to and extending from at least a portion of the shank, wherein at least some of the substantially closed loops of fiber-based material at least partially visually obscure the hook.

16. The fishing lure of claim 15, wherein the at least one hook has a trebel hooked end.

17. The fishing lure of claim 15, wherein the substantially closed loops of fiber-based material are attached to the shank to form a skirt.

18. A method of forming a fishing lure for capturing fish having teeth, the method comprising the steps of:
providing a shank; and
attaching a plurality of substantially closed loops of fiber-based material to at least a portion of the shank so as to extend from the shank.

19. The method of claim 18, wherein the step of attaching the plurality of substantially closed loops of fiber-based material is performed by a technique selected from the group consisting of sewing, tying, and a combination of sewing and tying.

20. The method of claim 18, further comprising the step of:
attaching at least one strand of additional material to the shank to provide the lure with increased attractiveness to prey.
